(19) United States
(12) Patent Application Publication
(10) Pub. No.: US 2018/0215484 A1
(43) Pub. Date: Aug. 2, 2018

(54) WATER PURIFICATION AND SANITARY PACKAGING

(71) Applicant: Timothy John Huff, Palisade, CO (US)

(72) Inventor: Timothy John Huff, Palisade, CO (US)

(21) Appl. No.: 15/885,566

(22) Filed: Jan. 31, 2018

Related U.S. Application Data
(60) Provisional application No. 62/452,824, filed on Jan. 31, 2017.

(51) Int. Cl. B65B 3/12; B01D 36/02; B01D 53/00; B01D 53/26; C02F 9/00; B29C 47/00; B29C 47/12; B65B 3/16; B65B 55/12; B65B 55/16; B65D 1/02; B65D 65/46; C08F 210/02; C08J 7/04

(52) U.S. Cl. CPC B65B 3/12; C02F 1/325; B01D 53/002; B01D 53/265; C02F 9/00; B29C 47/0054; B29C 47/0057; B29C 47/0004; B29C 47/12; B65B 3/16; B65B 55/12; B65B 55/16; B65D 1/0207; B65D 65/466; C08F 210/02; C08J 7/042; C02F 2201/32; B01D 36/02

(57) ABSTRACT

Providing clean water to a population is essential to maintain human life. Short and long-term issues may prevent a population from obtaining potable water. Transporting bulk water or prepackaged water (e.g., jugs, bottles, etc.) is an expensive and resource-intensive proposition. The population may be forced to utilize unsafe containers, further exacerbating the already adverse conditions. By providing empty, biodegradable bottles to a location which are then filled on-site from a potable or treated non-potable water source provides greater flexibility, resource savings, and safety. Additionally, the biodegradable bottles reduce the opportunity for the adverse effects experienced by non-degradable bottles which are often abandoned.

### CROSS-REFERENCE TO RELATED APPLICATIONS

The present application claims the benefit of priority from U.S. Provisional Patent Application 62/452,824 filed on Jan. 31, 2017 and entitled “Water Purification and Sanitary Packaging,” the entire disclosure of which is hereby incorporated by reference. Furthermore, the present application incorporates by reference for all purposes U.S. Provisional Patent Application 62/266,393 filed on Dec. 11, 2015 entitled “Amphora Film,” and U.S. Provisional Patent Application 62/570,511 filed on Oct. 10, 2017 entitled “The Amphora Film.”

### FIELD OF THE DISCLOSURE

The present disclosure is generally directed to providing potable water packaged to maintain potability in a biodegradable food-grade plastic film.

### BACKGROUND

Providing clean water to a population is a common and increasing issue throughout the world. Often the issue is long-term, such as due to population being forced into arid land as a result of war or political issues. Other times, the lack of clean water may be temporary, such as due to a natural disaster or failure of a water treatment facility.

A common solution is to package water at a first location and transport the water where it is needed. The costs of transporting large quantities of water is often prohibitive and, if can be maintained at all, is often maintained for only a short period. Transporting jugs, bottles, or other containers further reduces the efficiency of the delivery system, not only because of the weight of the water therein, but due to the empty space in and between bottles, pallets, and other wasted space. The plastic utilized in water jugs is often selected for durability and may accumulate in makeshift landfills. As a result, small amounts of trapped water or rainfall may provide breading grounds for disease-bearing insects and other pathogens.

One of the more economical solutions is to deliver a tank, often a tanker truck, of potable water to a site that is in need. Unless there is an on-site storage tank, and such a take is maintained in a sanitary condition, tanker trucks may be force to unload into individual containers. The need for water may be greater than the availability of tankers, therefore, slow delivery of water conflicts with a prompt delivery that enables subsequent reloadings and deliveries. Any individual who is unable to meet the tanker truck performing individual deliveries in time to receive the water may have to do without.

By combining the two prior solutions, tanker trucks may arrive at a location where the population is expected to provide their own containers or, alternatively, empty containers are also shipped in. Shipping empty containers requires a large volume and effectively amounts to shipping air. Shipped-in containers and especially population-provided containers must be maintained in a sanitary condition—often an impossible request. Population-provided containers may have been previously utilized for any number of other purposes, many of which are unsafe or outright toxic. While containers may be cleaned, it may be exceptionally rare, under such circumstances, for such containers to be cleaned and sanitized properly before being filled with potable water and may be susceptible to contamination after filling.

While trucks, aircraft, and other vehicles are often utilized to provide bulk water, prepackaged water, or bulk water and containers to a population in need, however, such solutions are expensive and untenable in many situations and durations. Often the need for water is the result of a natural or artificial disaster and roads, bridges, and landing strips may have been compromised, further hindering the ability to provide water to populations in need. The issue is further compounded by the relatively short period of time that humans can be without water before resorting to desperate measures or suffering the consequences of dehydration.

### SUMMARY

It is with respect to the above issues and other problems that the embodiments presented herein were contemplated. The exemplary systems, components, and methods of this disclosure have been described in relation to water bottling, containers, and related systems. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

It should be appreciated that, absent an explicit statement to the contrary, terms such as “container,” “package,” “bottle,” “vessel,” and the like are used interchangeably and refer to a physical structure having an enclosable interior portion operable to accommodate a substance. Similarly, word forms, such as “bottling” and “packaging,” are similarly utilized interchangeably.

By way of general introduction, and in one embodiment, a solution is provided wherein water bottles are provided that may be shipped flat and empty to a location until such time as they are needed and, once needed may be filed with a substance. The bottles may provide a biodegradable, food-grade plastic container that is sanitary and able to maintain water placed therein in a sanitary state. However, the biodegradable plastic, depending on conditions, may entirely break down, such as into inert or animal or plant usable/non-toxic materials. While condition specific, biodegradation may be substantially complete within one to five years thereby reducing land pollution and the need for post-use solid waste handling. By providing on-site bottling with the aforementioned bottles, potable bottled water may be provided to a population via an available water source, including a non-potable source, wherein the water is treated and bottled after treatment.

It should be appreciated that while many of the embodiments provided herein are directed towards packaging water, in other embodiments other liquids, solids, and gases are utilized without departing from the scope of the embodiments provided. The embodiments of the described container and certain embodiments utilizing the container may be modified, mutatis mutandis, to accommodate non-water substances. For example, one of ordinary skill in the art, with benefit of the disclosures provided herein, could apply modifications to certain embodiments such that the containers could be utilized to package granulated sugar, cooking oil, medical fluids, soft drinks, wine, beer, or other similar substances. Such modifications to accommodate non-water substances may be provided for substances that are effectively inert with respect to the container or at least inert to the degree required for the contained substance to be utilized for its intended purpose. Additionally, the embodiments provided herein enable a contained substance to be provided and maintained in a sanitary state for human consumption, however, other substances are not excluded by the embodiments provided. Substances other than water, may include, but are not limited to, water-based solutions and/or other liquids (e.g., soft drinks, wine, beer, oils, medical liquids, etc.), solids (e.g., flour, grain, sugar, pre-hydrated medical compounds, etc.), gases, and combinations thereof. While some substances may not have a need to be packaged and maintained in the sanitary state afforded by the embodiments, the utilization of such substances is not excluded.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

### BRIEF DESCRIPTION OF THE DRAWINGS

The present disclosure is described in conjunction with the appended figures:

FIGS. 1A-1B depict a bottle filling system in accordance with embodiments of the present disclosure;

FIG. 2 depicts a plastic sheet formable into a bottle in accordance with embodiments of the present disclosure; and

FIG. 3 depicts a finished bottle in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to physical components and their interrelationships. However, to avoid unnecessarily obscuring the present disclosure, the following description omits well-known structures, components, and devices that may be shown in block diagram form and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

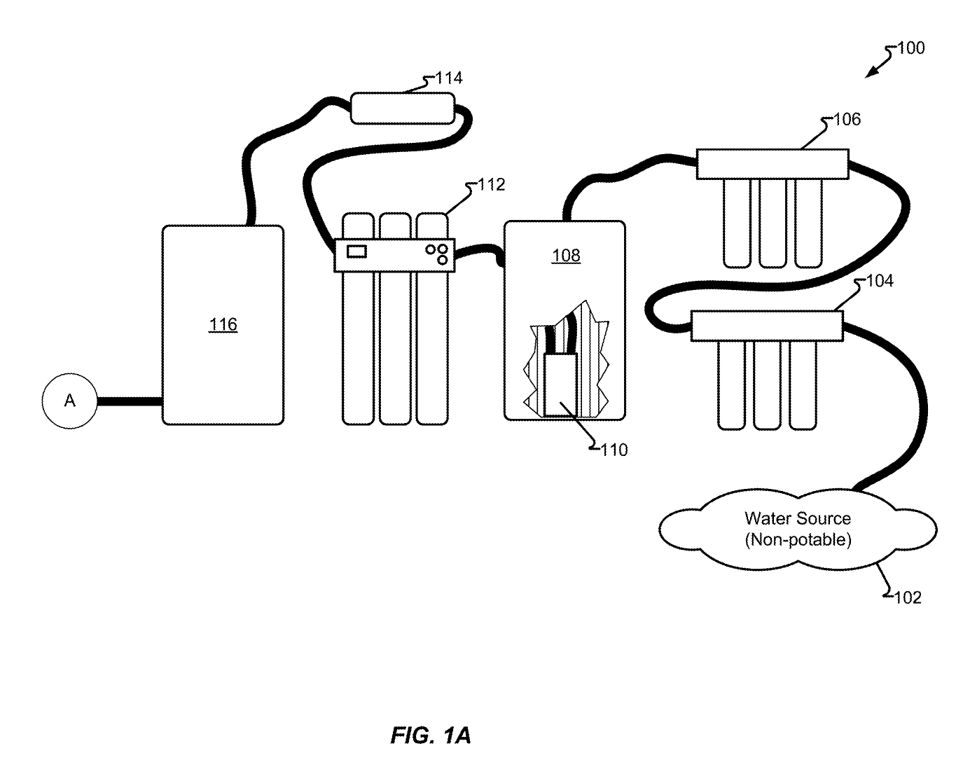

FIGS. 1A-1B depict bottle filling system 100 in accordance with embodiments of the present disclosure. In one embodiment, water is accessed from water source 102. Water source 102 may be known or suspected to be non-potable. Water from water source 102 may be treated or untreated, if known to be potable. If treatment is required, one or more treatment processes may be applied. Treatments may comprise physical (e.g., screening, filtering, skimming, de-gassing, etc.), chemical (e.g., flocculation agents, pH neutralizers, etc.), anti-pathogen (e.g., chlorination, ultraviolet sterilization, ozone, etc.), and/or other treatments as may be appropriate for a particular water source 102.

In another embodiment, a pump (not shown) may be deployed to provide the water from water source 102 to pre-filter 104. Pre-filter 104 may remove relatively large solids. Carbon pre-filter 106 provides additional filtering for progressively smaller solids and certain liquids, such as high viscosity oils. One or both of pre-filter 104 and carbon pre-filter 106 may require manual and/or automatic backflushing and/or filter replacement to maintain efficiency and efficacy.

In another embodiment, filtered water held in graywater tank 108 and pumped, as needed, by pump 110 into reverse osmosis subsystem 112. Water then flows through ultraviolet sanitizer 114 to address any microbial life that may still remain. Now-potable water may be held in tank 116 which may be equipped with a level/overflow switch to selectively energize/de-energize pump 110 and/or other components.

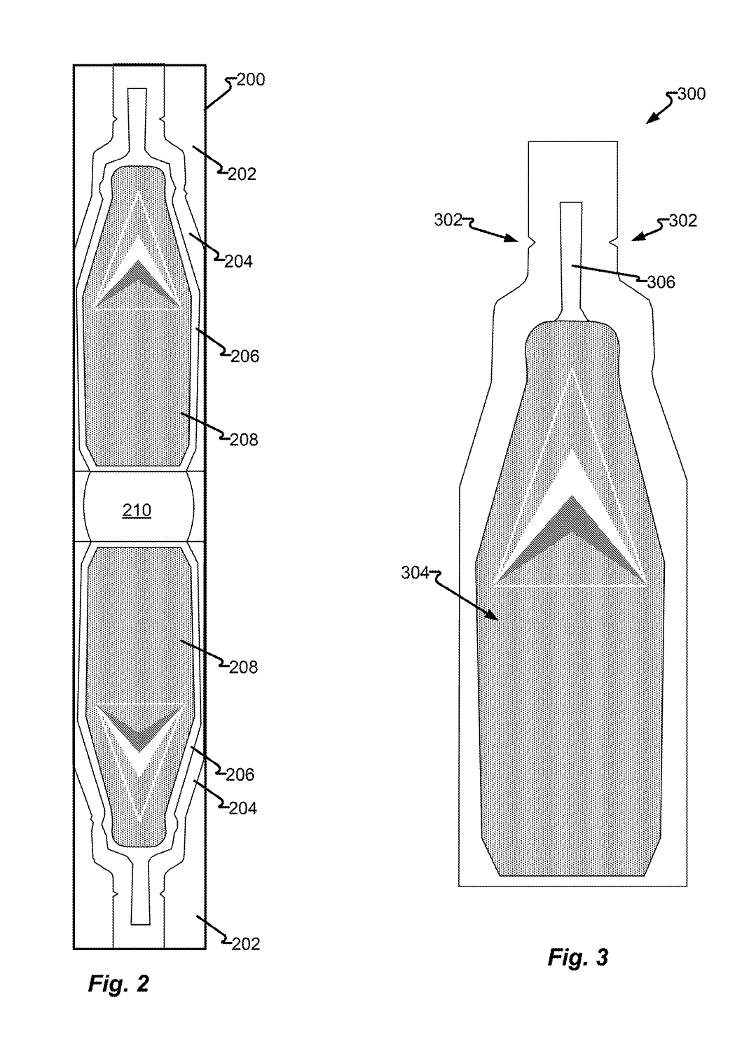

With reference now to FIG. 1B, water is provided to bottler 122, compressor 118 provides air necessary to perform mechanical acts (e.g., operate air-powered pistons, etc.). Air stripper 120 uses a chemical reaction to lower the temperature of air in the system to at or near absolute 0 (−459.67° F. (−273.15° C.)). By doing so, the air stripper 120 removes all moisture in air; thus, removing or at least lowering the number and concentration of contaminants from the compressor 118 and its ancillary component parts. Bottler 122 provides a filling apparatus for the delivery of water, temporary opening the spout (see, FIG. 3, element 306) for filling, and a sealing apparatus. Sealing may be performed by heat, ultrasonic welding, bonding, or other means appropriate to preserve the water without damaging, or prematurely degrading, the bottle.

In another embodiment, manual or automatic means take bottle blanks 124, attach ones of bottle blanks 124 to one of filling tap 123 of bottler 122, which then fills and seals the bottles and completed bottles 126 are then ready for distribution.

In another embodiment, bottle blanks 124 may be fan-folded, spooled, or otherwise maintained in a continuous form requiring folding and sealing to form the chamber portion of the bottle. In another embodiment, bottle blanks 124 may be pre-sealed on all but the spout, whereby the chamber is formed but open at the spout for filling.

In another embodiment, bottler 122 may utilize air pressure to open the spout to accept one of tap 123 for filling. Air pressure utilized may be positive pressure, such as from compressor 118, negative, such as vacuum pump, or utilize a fluid other than air. For example, an inert gas (e.g., nitrogen, argon, etc.), sanitizing gas (e.g., chlorine dioxide, etc.), inert liquid (e.g., additional water, etc.), and/or sanitizing liquid (e.g., iodine solution, phosphoric acid, dodecylbenzenesulfonic acid, etc.). However, as previously discussed, the selection and utilization of any gas or liquid utilized to open, hold open, and/or to sterilize the interior chamber of a bottle prior to filling requires such a selection and utilization that does not damage the bottle and/or not render the water unfit for drinking.

Power supply 130 may provide electrical and/or mechanical energy to one or more components of bottle filling system 100 and may comprise wind powered electrical generator 132, solar power panel 134, and/or propane 136 powered generator. Although not specifically depicted in FIG. 1B, a person of ordinary skill in the art will understand that power supply 130 may come from any number of other sources not depicted in FIG. 1B. For example, the bottle filing system 100 may be powered by one or more of a, for example, battery, biofuel, fossil fuel (e.g., gasoline, coal, and diesel fuel, etc.), and atomic energy source (not shown). Furthermore, and although not discuss herein, one of ordinary skill in the art will appreciate the tubes, hoses, pumps, valves, power cords, supports, and other well-known components and their variants, that may be utilized in order to practice the embodiments disclosed.

System 100 may be entirely contained within a truck, trailer, container, or other vehicle to facilitate rapid deployment. In other embodiments, one or more components may be separated for transport, such as by smaller vehicles, a plurality of vehicles, pack animal, or human transport.

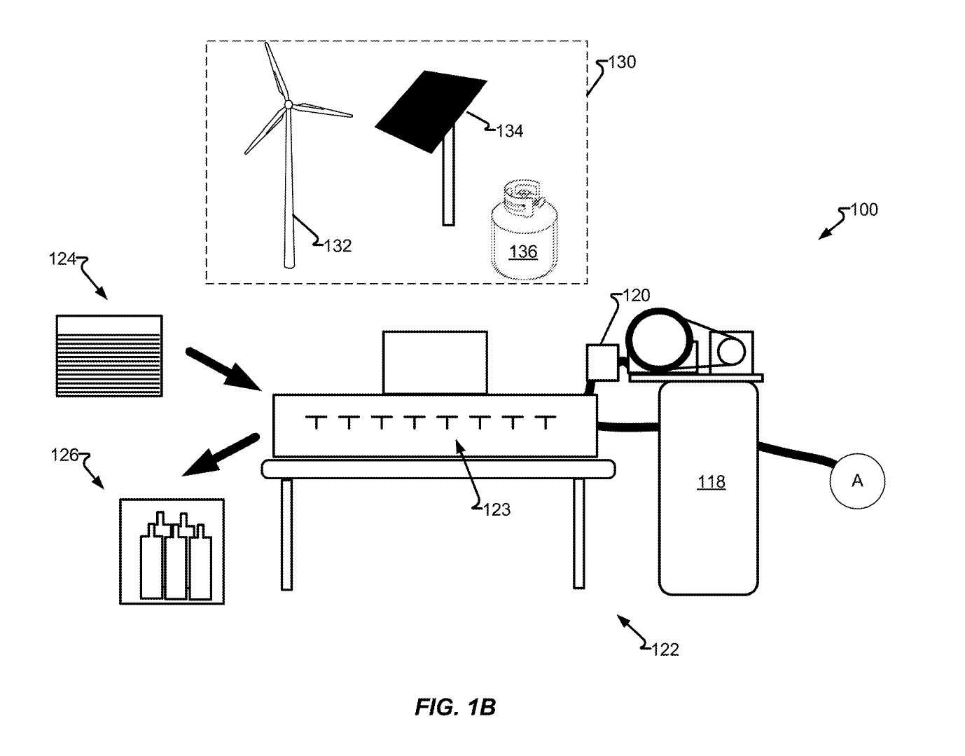

FIG. 2 depicts plastic sheet 200 formable into a bottle in accordance with embodiments of the present disclosure. In one embodiment, plastic sheet 200 illustrate one of a continuous or segmented plurality of plastic sheets 200. Plastic sheet 200, in the state illustrated in FIG. 2, provides a highly compact form factor for what may eventually be filled to accommodate water in an internal chamber. Plastic sheet 200 may comprise a biodegradable plastic such as “Amphora film,” as described in U.S. Provisional Patent Application 62/266,393.

The Amphora Film is an innovative biodegradable food-grade plastic film. The Amphora Film is synthesized using a proprietary method employing microbial catalysts (a.k.a. bioadditives) bound to layered polyethylene (PE) and nylon (PA) films. Microbial catalysts are readily available from various vendors and are employed using the proprietary method in order to maximize the biodegradation, strength, and elasticity of the layered film for use in the desired application. The Amphora Film can be used to package any consumer food product. For example, this new biodegradable film is especially useful for the purpose of bottling water and other liquids, such as wine and beer. The proprietary manufacturing process employing polyethylene, nylon, and microbial catalysts is provided here:

Step 1. Copolymerizing polyethylene (C₂H₄)ₙ and ethylene (C₂H₄) resulting in hydrocarbon chain with shortened branches. This stronger and more elastic polyethylene is known as linear low-density polyethylene (LLDPE), which provides a film with higher tensile strength and higher puncture resistance.

Step 2. Selecting nylon 66 (C₁₂H₂₂N₂O₂)ₙ to be layered onto the LLDPE. Biaxial-oriented nylon is selected for its simultaneous high tensile strength, oxygen (02) impermeability, and carbon dioxide (CO₂) permeability. Furthermore, nylon 66's oligomers are naturally degraded by Gram-negative bacterium species Flavobacterium and Pseudomonas.

Step 3. Synthesizing specific ratios of microbial catalysts to nylon 66—LLDPE film. The nylon 66—LLDP film consists of hydrophobic polymers, which are broken down to constituent parts. The constituent parts attract microorganisms through quorum sensing. Bacteria use quorum sensing to coordinate certain behaviors based on the local density of the bacterial population. The coordinated bacteria population degrade the nylon 66—LLDP film through hydrolysis (a.k.a. anaerobic biodegradation). The resulting methanogenesis creates methane (CH₄), water, and carbon dioxide (CO₂):

C₆H₁₂O₆→3CH₄+3CO₂

Step 4. Layering multiple nylon 66—LLDP films. These separate layers expedite the biodegradation process.

In embodiments, the innovative biodegradable food-grade plastic film described herein can be manufactured using several alternate steps. For example, a blowing and extrusion process may be employed in which the molten plastic bridgeable film is blown and extruded by a system known allowing the molecules of the film to orient as it cools. Further, the blown film may be shaped on one or more dies as the film cools, thereby causing molecules to become oriented as desired. Further, the film may be stretched to a desired thickness. Further the biodegradable film may be exposed to medical grade ultra violet light to the film in order to insure complete sterilization and sanitation of the film resulting in food grade quality biodegradable plastic film.

In one embodiment, plastic sheet 200 comprise one of bottle blank 124 (see, FIG. 1B). Plastic sheet 200 may comprise extraneous portion 202 which may be provided as a consequence of certain manufacturing processes and, if desired, removed prior to, during, or after filling. In one embodiment, plastic sheet 200 may comprise two mirror-image halves for a bottle. However, in other embodiments, structural differences between the two halves may be provided. Plastic sheet 200 comprises sealing area 204 to be mated to a corresponding sealing area 204, sidewall portion 206, chamber portion 208, and bottom portion 210.

The structure of plastic sheet 200 comprising multiple empty bottle blanks 124 is particularly advantageous over the prior art because the plastic sheet 200 is considerably less expensive to store and ship as compared to fully-formed empty bottles. The prior art comprises fully-formed empty bottles that, although light in weight because they are empty of liquid, still take up considerable volume in shipping containers, resulting in limiting the number of empty bottles that may be shipped or raising the costs substantially associated with shipping the fully-formed empty bottles. The present invention overcomes this problem by allowing for the shipment of flat, or substantially flat, empty plastic sheets 200 comprising numerous empty bottle blanks 124. The structure of plastic sheets 200 comprising empty bottle blanks 124 permits the compact and efficient storage and shipment of empty bottle blanks without extraneous air. Thus, more empty bottle blanks 124 can be efficiently stored and shipped to locations where water will be purified and bottled according to the present invention.

FIG. 3 depicts finished bottle 300 in accordance with embodiments of the present disclosure. In one embodiment, notches 302 are provided to facilitate opening of bottle 300. The notches indicate and facilitate tearing of bottle 300 across spout 306 to provide access to the contents within chamber 304. Optionally, a resealable closure, valve insert, or other means may be provided in spout 306 to facilitate selective access to the contents of chamber 304.

Specific details were given in the description to provide a thorough understanding of the embodiments. However, it will be understood by one of ordinary skill in the art that the embodiments may be practiced without these specific details. While illustrative embodiments of the disclosure have been described in detail herein, it is to be understood that the inventive concepts may be otherwise variously embodied and employed, and that the appended claims are intended to be construed to include such variations, except as limited by the prior art.

I claim:

1. A bottle filling system comprising:
a water source;
a plurality of filters;
one or more pumps;
an energy source;
a filling tap;
a plurality of bottle blanks, wherein the bottle blanks configured to fit the filling tap, and wherein the bottle blanks are folded flat such that air is evacuated from the bottle blanks.

2. The bottle filling system of claim 1, wherein the plurality of filters comprise:
a pre-filter;
a carbon filter;
a reverse osmosis system; and
a ultraviolet light sanitizer.

3. The bottle filling system of claim 1, wherein the plurality of filters consist of:
a pre-filter;
a carbon filter;
a reverse osmosis system; and
a ultraviolet light sanitizer.

4. The bottle filling system of claim 1, wherein the plurality of bottle blanks comprise a plurality of plastic sheets, each of the plurality of plastic sheets comprising:
a first sealing area sealable to a corresponding second sealing area;
a sidewall portion;
a chamber portion;
a spout; and
a bottom portion.

5. The bottle filling system of claim 4, wherein each of the plurality of plastic sheets further comprises:
two opposing notches, the two opposing notches disposed at a distal end of each of the plurality of plastic sheets, the distal end being disposed at an opposing end of each of the plurality of plastic sheets as the bottom portion of each of the plurality of plastic sheets; and
a spout disposed between the two opposing notches, wherein the opposing notches are usable to facilitate opening of each of the plurality of bottle blanks.

6. The bottle filling system of claim 1, further comprising:
a compressor; and
an air stripper.

7. The bottle filling system of claim 1, wherein the bottle filling system is contained within a mobile container, the mobile container having a volume substantially between 5,000 and 6,000 dekaliters.

8. A biodegradable plastic bottle, the bottle comprising:
two opposing plastic sheets, the two opposing plastic sheets comprising:
a sealing area;
a sidewall portion;
a bottom portion, wherein the sealing area, the sidewall area, and the bottom form a chamber portion, the chamber portion forming a volume of empty space; and
a spout, wherein the spout is connected to the chamber portion and the spout is disposed at the end of the bottle at the opposite end of the bottom portion.

9. The biodegradable plastic bottle of claim 8 further comprising:
two opposing notches disposed at the opposite end as the bottom portion, wherein the spout is disposed between the two opposing notches, wherein the opposing notches are usable to facilitate opening of the chamber portion via the spout.

10. The biodegradable plastic bottle of claim 8 further comprising at least one of a resealable closure, valve insert, or other means may to close the spout to facilitate selective access to the contents of chamber.

11. The biodegradable plastic bottle of claim 8 prepared by a process comprising the steps of:
copolymerizing polyethylene (C₂H₄)ₙ and ethylene (C₂H₄) resulting in linear low-density polyethylene;
selecting nylon 66 (C₁₂H₂₂N₂O₂)ₙ to be layered onto the linear low-density polyethylene; and
adding microbial catalysts to the nylon 66—low-density polyethylene film.

12. The biodegradable plastic bottle of claim 11 prepared by a process further comprising the steps of:
layering a plurality of nylon 66—low-density polyethylene—microbial catalyst films.

13. A method of manufacturing a biodegradable plastic film comprising:
copolymerizing polyethylene (C₂H₄)ₙ and ethylene (C₂H₄) resulting in linear low-density polyethylene;
layering nylon 66 (C₁₂H₂₂N₂O₂)ₙ the linear low-density polyethylene, resulting in a nylon 66—low-density polyethylene film; and
adding microbial catalysts to the nylon 66—low-density polyethylene film, resulting in a nylon 66—low-density polyethylene—microbial catalyst film.

14. The method of manufacturing a biodegradable plastic film of claim 13 further comprising:
layering a plurality of nylon 66—low-density polyethylene—microbial catalyst films.

15. The method of manufacturing a biodegradable plastic film of claim 13 further comprising:
employing a printing membrane for food grade film allowing for custom printing on an outer surface of the biodegradable plastic film.

16. The method of manufacturing a biodegradable plastic film of claim 13 further comprising:
blowing and extruding the layering a plurality of nylon 66—low-density polyethylene—microbial catalyst films in the molten phase, wherein the film molecules are oriented during the cooling phase

17. The method of manufacturing a biodegradable plastic film of claim 13 further comprising:
stretching the biodegradable plastic film to a desired thickness.

18. The method of manufacturing a biodegradable plastic film of claim 16 further comprising:
shaping the biodegradable plastic film using dies, wherein the molecules of the molten biodegradable plastic film are oriented

19. The method of manufacturing a biodegradable plastic film of claim 18 further comprising:
applying medical-grade ultra violet light to the biodegradable plastic film, wherein the biodegradable plastic film is sterilized resulting in a food-grade quality biodegradable plastic film.

20. The method of manufacturing a biodegradable plastic film of claim 19 further comprising:
stretching the biodegradable plastic film to a desired thickness.
